(19) United States
(12) Patent Application Publication
(10) Pub. No.: US 2003/0028768 A1
(43) Pub. Date: Feb. 6, 2003

(54) Inter-enterprise, single sign-on technique

(76) Inventors: Lorenzo De Leon, Arlington Heights, IL (US); Michael Kleszinski, Manteeno, IL (US); Kevin Dooley, Chicago, IL (US); Jack Lund, Chicago, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/920,525

(22) Filed: Aug. 1, 2001

(51) Int. Cl. H04L 9/00

(52) U.S. Cl. 713/169; 713/180

(57) ABSTRACT

A method of connecting an end user associated with a first organization to an application hosted by a second organization using a double blind authentication technique, wherein the identity of the end user is kept from the second organization and the identity of the second organization is hidden from the end user, includes exchanging digital certificates between the first organization and the second organizations, sending an authenticated and encrypted first message using a digital certificate from the first organization to the second organization, and requesting a virtual user (ID) for use by the end user. Thereafter, the method validates the digital certificate at the second organization, decrypts the first message sent by the first organization, and responds to the first message by sending an authenticated and encrypted response message including an authorized virtual user ID to the first organization. The first organization then authenticates the end user, maps the end user's user ID to the appropriate virtual user ID, and sends a second authenticated and encrypted message to the second organization including a session initialization request. The second organization then replies to the second message with an authenticated and encrypted reply message which includes a session ID.

### FIELD OF THE INVENTION

The present invention relates generally to electronically connecting users to an application service provider, and more particularly, to securely connecting users to an application service provider through a sponsor site in a manner that provides double blind authentication.

### BACKGROUND OF THE INVENTION

In a distributed business model, organizations such as banks, financial investment institutions, healthcare organizations, as well as many others, often do business with not only their direct customers, but with all of their alliances, financial institutions, and users. These expanded relationships can prove very profitable for the organizations because these organizations can offer their applications and services to as many users as possible.

One way that organizations can extend their reach into the marketplace is by reselling their services through sponsor organizations with established customer bases. These sponsor organizations, while usually smaller in size, may in some cases be just as large, if not larger than the service providing organization. Coincidentally, the sponsor organizations want to offer their users as many services as possible, even though these sponsor organizations decide in many cases that it is not cost effective for them to develop all of the applications to be offered to a customer themselves or even to purchase or license these applications from other organizations.

There are of course many reasons why smaller sponsor organizations, like local banks, want to provide their users with a wide variety of services, including profit, and the advantage of offering their customers “one stop shopping” for a vast array of applications and services. These additional services enable the organization to obtain all of a customer's business, some of which may be extremely profitable. Other advantages include the ability of presenting the appearance of being a bigger and more feature rich organization than they really are. These last points explain why some sponsor organizations prefer to not disclose to their users that a service the sponsor organization is providing is not really theirs, but is that of another organization.

The ability to keep the identity, if not the existence, of a different organization providing the service hidden from the sponsor organizations' end users is also important for customer retention purposes. Some sponsor organizations want to prevent the possibility that their users would, in the future, bypass the sponsor organization altogether, and go directly to the organization providing the service. For the same reason, it is also important for the sponsor companies to keep the identities of their users hidden from the organization providing the service in order to prevent the companies providing the services from directly marketing to the sponsor companies' users.

Prior art, multi-tiered, application service provider (ASP) systems are simplistic in design and have glaring security flaws which have led to serious security breaches. In particular, with the prior art systems, the organization providing the service, referred to as an application service provider, gives a sponsor organization a number of user identifications (IDs) and passwords and the sponsor organization then stores this information in a persistent storage. The problem with this design is that, when hackers breach the security at the sponsor organization, the hackers are able to gain access to the persistent storage and obtain valid user IDs and passwords to the application service provider, giving the hackers unfettered access that is very difficult to detect.

Moreover, the multi-tiered ASP systems found in the prior art typically require multiple sign-ons by the end users, which is cumbersome and undesirable. Additionally, the prior art, multi-tiered ASP systems offer nothing in the way of keeping the identity of the ASP and the identities of the end users hidden from one another.

### SUMMARY

A method of connecting an end user associated with a first organization to an application hosted by a second organization which uses a double blind authentication technique, wherein the identity of the end user is kept from the second organization and the identity of the second organization is hidden from the end user. The method exchanges digital certificates between the first organization and the second organizations, sends an authenticated and encrypted first message using a digital certificate from the first organization to the second organization, and requests a virtual user identification (ID) for use by the end user. Thereafter the method validates the digital certificate at the second organization, decrypts the first message sent by the first organization, and responds to the first message by sending an authenticated and encrypted response message including an authorized virtual user ID to the first organization. The first organization then authenticates the end user, maps an end user's user ID to the appropriate virtual user ID, and sends a second authenticated and encrypted message to the second organization including a session initialization request. The second organization then replies to the second message with an authenticated and encrypted reply message which includes a session ID.

### BRIEF DESCRIPTION OF THE DRAWINGS

The present invention is illustrated by way of example and not limitation in the accompanying figures, in which like reference numerals indicate similar elements, and in which:

FIG. 1 is a block diagram of a system incorporating an inter-enterprise, single sign-on technique;

FIG. 2 is a flowchart representation of the steps used in executing a connection of organizations and users with an inter-enterprise, single sign-on technique; and

FIG. 3 is a component diagram implementing an inter-enterprise, single sign-on technique.

### DETAILED DESCRIPTION OF THE PREFERRED EMBODIMENTS

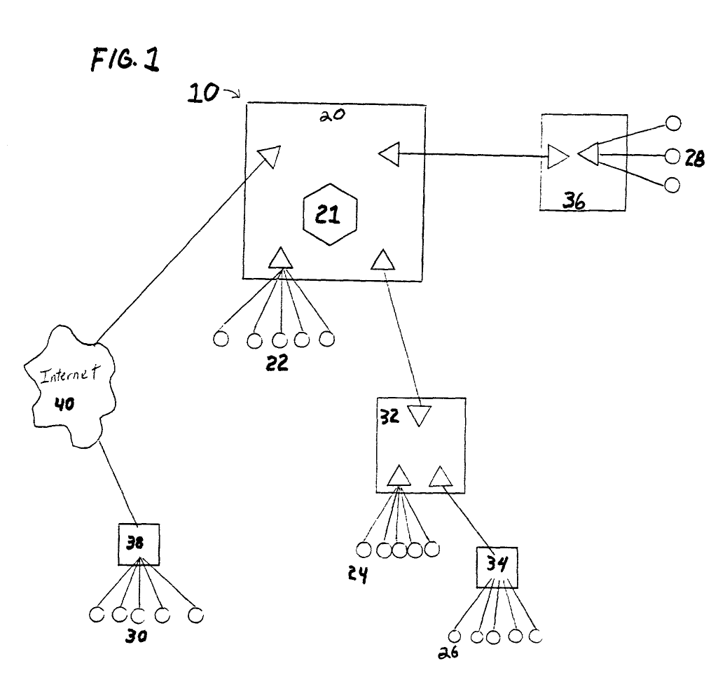

FIG. 1 illustrates a group of interconnected entities which can utilize an interenterprise, single sign-on technique referred to herein as an inter-enterprise, single sign-on system 10. The system 10 includes an organization or ASP 20 which provides a service or access to an application 21 for many different end users. Some of the end users, such as those shown at 22, may be direct customers of the ASP 20 and may access the application 21 directly. Other end users, such as those shown at 24, 26, 28, and 30 obtain indirect access to the application 21 from the ASP 20 by connecting through sponsor sites or organizations such as organizations 32, 34, 36 and 38.

The end users 22, 24, 26, 28, and 30 are connected to the ASP 20 through an electronic network which may include the internet 40 or a variety of other connections, such as ordinary telephone (pots) lines or dedicated access lines including, for example, T3, T1 (any fractional amount thereof such as 64K, 256K, etc. lines), DSL, or ISDN lines, etc. Of course any other suitable or desirable electronic network may be used as well. As described in detail below, appropriate measures should be implemented to assure adequate security of the connections.

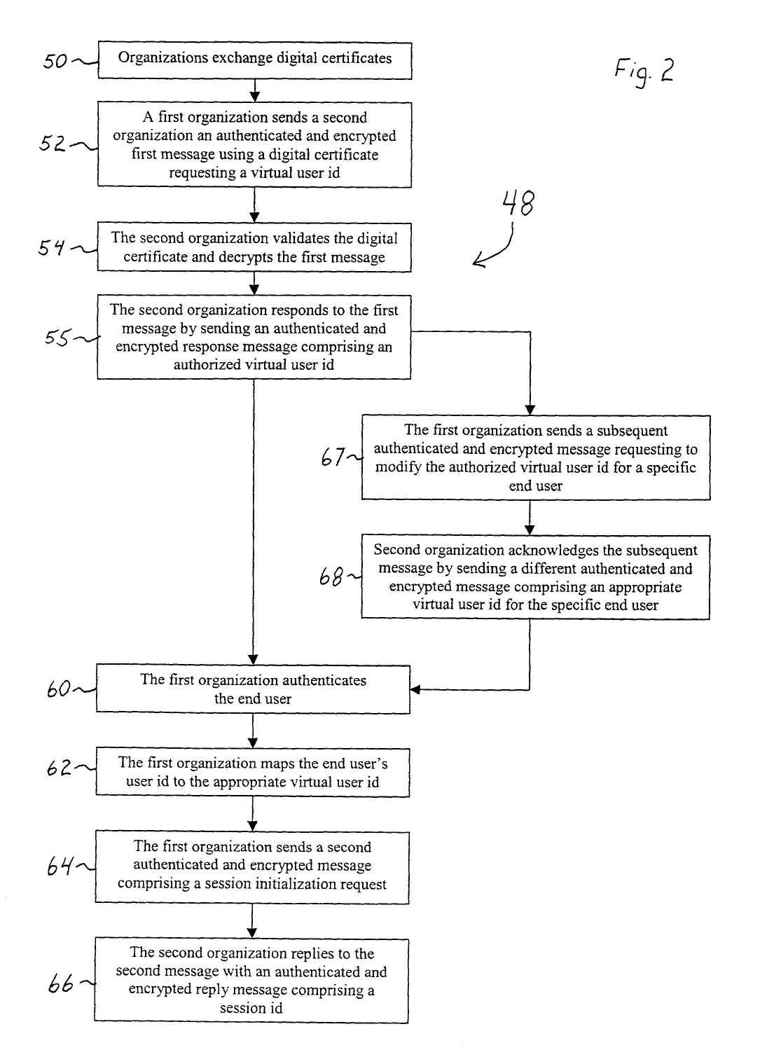

Referring now to FIG. 2, an inter-enterprise, single sign-on technique 48 includes a step 50 which exchanges digital certificates between the organizations, such as the organizations 20 and 32, through a manual process. Most commonly, this exchange will be done using the U.S. Mail, Courier Mail, or any other courier or messenger service. Examples of Courier Mail include Federal Express, UPS, Airborne Express, Emery, Purolator, DHL, etc. While not recommended for security reasons, the digital certificates could also be transmitted through electronic mail or other electronic means.

Digital certificates and signatures are an underlying technology of Public Key Infrastructure (PKI), which is known in the art. The purpose of digital certificates is to aid PKI as an authentication mechanism. In other words, digital certificates are used to assist an organization, such as the ASP 20, in ensuring that messages or information sent to it are from a trusted source based on the unique digital certificate associated with that source. The digital certificates typically include just a few lines of computer code. By passing the digital certificates along with the actual content of the message or other information, the organizations are able to determine that the information came from the source identified in the message.

Once the organizations have exchanged digital certificates, a step 52 sends an authenticated and encrypted first message using a digital certificate from the first organization, such as the sponsor site 32 of FIG. 1, to a second organization, such as the ASP 20. This first message includes a request for a virtual user ID for use by an end user, such as one of the end users 24 or 26. While the sponsor site 32 may request only one virtual user ID, it will most likely request a number of virtual user IDs. These virtual user IDs will then be mapped to specific end users 24 or 26.

The message sent from the sponsor site 32 to the ASP 20 may be encrypted using any available encryption technique. For example, Public Key Infrastructure encryption could be used, which works with digital certificates and uses two packets of code, called a public key and a private key. Both packets of code describe an encryption and decryption scheme and allow two users to pass encrypted content to each other using a unique encryption scheme, as is known in the art.

This encryption technique, while quite complex, is a very secure technique. Previously if a hacker cracked a company's encryption scheme, he or she could read all of the data being sent to and from that company's server. With PKI however, each set of keys uses a unique encryption scheme, which means that hackers have to crack encryption schemes every time they encounter a new set of keys.

A preferred method of utilizing the Public Key Infrastructure, but not the only one, is by sending the messages using S/MIME via HTTP/S, which is fast becoming the standard way to authenticate and encrypt e-mail messages. S/MIME is different from most security mechanisms because it is designed to be an end-to-end security mechanism, wherein the messaging backbone doesn't generally participate in S/MIME except to ship mail messages around.

S/MIME is a framework for security that takes two sets of protocols and combines them into a single secure message. In particular, the MIME standards describe how message body parts can be encoded and sent safely through unfriendly and destructive networks. Several RSA Data Security standards exist, which include: PKS #1 (RSA public key encryption), PKS #7 (Cryptographic message syntax), and PKS #10 (Public Key certificate request syntax).

S/MIME offers two basic services: “signing” of messages and encryption. Signing is used to certify that a particular message came from a particular sender, while encryption is used to hide the contents of the message. An organization can use one or both of the services, depending on its needs. In both cases, S/MIME requires public keys, and thus, each organization, such as the ASP 20 and the sponsor site 32, will generally have a signed public key.

While not required, the sponsor site 32 may include, as part of its message, instructions to the ASP 20 requesting appropriate authorizations for a set of virtual users to obtain access to a specific application, such as the application 21, or perhaps to multiple applications. The ASP 20 may grant the appropriate authorizations at the same time that the ASP 20 sends the sponsor site 32 a session ID (described below). Allowing access to the application 21 only to end users that have been granted authorization, provides an additional layer of security for the ASP 20. Also, the instructions for authorizations are a subset of the sponsor site's authorizations. In other words, the sponsor site 32 cannot bestow authorizations it is not entitled to for its end users 24 and 26.

At a step 54, the ASP 20 validates the digital certificate sent by the sponsor site 32 and decrypts the first message. These steps are preferably performed using the techniques described above, but could be performed using any other desired technique. Once the ASP 20 reviews the content of the first message, at a step 55 the ASP 20 responds by sending an authenticated and encrypted response message to the sponsor site 32. This response message includes at least one authorized virtual user ID for use by an end user 24 or 26 of the sponsor site 32. Preferably, the authorization, decryption, validation, and encryption performed in these steps use the techniques described above.

It should also be noted that the number of virtual user IDs included in the response message preferably correlates with the number requested by the sponsor site 32 in the first message. For example, if the sponsor site 32 requests ten virtual user IDs, the ASP 20 should respond with a list of ten authorized virtual user IDs. These user IDs are referred to as “virtual” because the sponsor site 32 does not provide the ASP 20 with the identities of its users 24 and 26. Thus, at the ASP 20, the real end user is known only as “end user,” or some other nonspecific name.

At a step 60, the sponsor site 32 authenticates the end user 24 or 26 as he or she logs on to an application on the server of the sponsor site 32. While the step of authenticating the end user 24 or 26 may be performed at any time, it is most commonly performed after the end user 24 or 26 logs on to the web server of the sponsor site 32. Using or validating a user ID and password (also called a sign-on) is the most common method of accomplishing the verification of an end user. Because the end users 24 and 26 are only required to enter one user ID and password, it is a relatively minor inconvenience when compared to the security provided and the, perhaps unknown, multiple connections made by the system.

At a step 62 the sponsor site 32 maps the end user's user ID to the appropriate virtual user ID. Typically, this action is performed by the sponsor site's server. At a step 64, the sponsor site 32 sends a second authenticated and encrypted message to the ASP 20. The second message includes a session initialization request. Here too, the authentication and encryption is preferably performed using the techniques described above.

At a step 66, the ASP 20 replies to the second message with an authenticated and encrypted reply message including a session ID. Preferably, the reply message is sent as an S/MIME message. Passing the session ID as a session cookie for the end user's web browser is one method of sending a session ID to the sponsor site 32. In addition to the session ID, the ASP 20 may include a Uniform Resource Locator (URL) in the message to the sponsor site 32, which is essentially a networked extension of a standard filename. Once an end user 24 or 26 has a URL and a session ID, the user is able to make requests for access to applications provided by the ASP 20 given the authorizations assigned to the respective virtual user.

The use of session IDs is important to the concept of “user sessions.” Typically, HTTP/S sessions do not have the concept of state; meaning that each HTTP/S request does not have the knowledge of any previous requests. With the initiation of a user session, a system can expire that session if the session becomes stale (i.e., if too much time has elapsed since the last activity). The initiation of a user session also provides the opportunity to authenticate the user with each HTTP/S request in an invisible manner. Thus, if an unauthorized user is online, his or her session can be immediately terminated.

The use of session IDs is very beneficial in terms of security because it prevents a user from walking away from his or her system and having someone else, who may be unauthorized, from using his or her computer. This concept may be easily implemented by monitoring the session ID to ensure that the session does not become stale. In other words, making sure that a predetermined amount of time has not elapsed since the last user request.

In some cases, the step 52 of sending the first message and the step 55 of responding to the first message is followed by a step 67, where the sponsor site 32 sends a subsequent authenticated and encrypted message to the ASP site 20, requesting to modify the authorized virtual user ID for a specific end user 24 or 26.

At a step 68, the ASP 20 acknowledges the subsequent authenticated and encrypted message and sends a different authenticated and encrypted message to the sponsor site 32 comprising an appropriate virtual user ID for the specific end user 24 or 26. These messages may be authenticated and encrypted using the techniques described above.

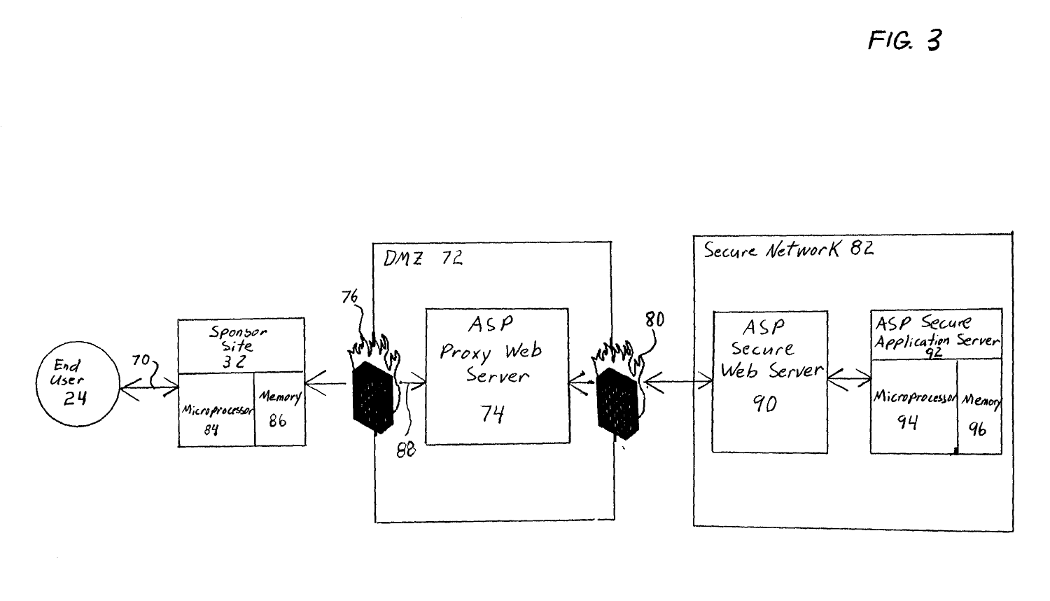

Referring now to FIG. 3, the end user 24 is connected to the sponsor site 32 via an electronic network 70. The sponsor site 32 is also connected to a demilitarized zone (DMZ) 72 (described below) which secures an ASP proxy web server 74 by use of an external firewall 76 and an internal firewall 80. The DMZ 72 is also connected to a secure network 82.

The sponsor site 32 includes a microprocessor 84 and a memory 86. A first software routine is stored in the memory 86 and is adapted to perform a series of steps, described below. The sponsor site 32 is connected to the ASP proxy web server 74 via an encrypted and secure channel. This connection includes a link 88 and the external firewall 76. The external firewall 76 also restricts network access for the user 24 to only those things that are necessary to the system.

The ASP proxy web server 74 is connected to an ASP secure web server 90. However, the internal firewall 80 is established along the connection and resides between the two components 74 and 90. Thus, the ASP proxy web server 74 is located between the two firewalls 76 and 80. The region between the two firewalls 76 and 80 is sometimes referred to in the art as the demilitarized zone (DMZ) 72. The ASP proxy web server 74 is locked down as much as possible and the DMZ 72 is designed for security purposes. As a result, no database access is allowed from within the DMZ 72. Likewise, no data is housed in the DMZ 72. The DMZ 72 is an area where many hackers have gained access and once they have access, they are able to steal or change whatever data is there, including for example HTML files, customer lists, credit card information, etc.

The ASP proxy web server 74 proxies all requests to the ASP secure web server 90 which is connected to an ASP secure application server 92. The ASP secure application server 92 has a second microprocessor 94 and a second memory 96. A second software routine is stored in the second memory 96 which is adapted to perform a number of steps, which will be described below. The ASP secure web server 90 and the ASP secure application server 92 are included as part of the secure network 82.

The first software routine stored in the first memory 86 works in conjunction with the first microprocessor 84 by sending an authenticated and encrypted first message using a digital certificate from a first organization, such as the sponsor site 32, to a second organization, such as the ASP 20. The first message includes a request for at least one virtual user ID for use by one or more end users, such as the end user 24. The software routine stored in the first memory 86 is adapted to perform the steps of authenticating the end user(s) and mapping the end user's user ID to an appropriate virtual user ID. Additionally, the software routine stored in the first memory 86 and run on the first microprocessor 84 complete the step of sending the second authenticated and encrypted message from the first organization, such as the sponsor site 32, to the second organization, such as the ASP 20. The second message includes a session initialization request, e.g., a request for a URL and a session ID for a specific end user, such as the end user 24.

The second microprocessor 94 and the second software routine stored in the second memory 96 validate the digital certificate sent in the first message and decrypt the first message sent by the first organization. The second microprocessor 94 and the second software routine stored in the second memory 96 respond to the first message by sending the authenticated and encrypted response message. This authenticated and encrypted response message includes at least one virtual user ID. Additionally, the second microprocessor 94 and the second software routine stored in the second memory 96 perform the step of replying to the second message with an authenticated and encrypted reply message including a session ID.

The software routines stored in the first and the second memories 86 and 96, and adapted to be executed on the first and the second microprocessors 84 and 94 are also responsible for performing a variety of additional tasks. For example, if desired, the second software routine stored in the second memory 96 may be programmed to perform the step of monitoring the end user's 24 session ID to ensure that the session E) does not become stale. The first software routine stored in the first memory 86 may also perform the step of sending a subsequent authenticated and encrypted message from the first organization to the second organization requesting a modification of the authorized virtual user ID for a specific end user. In turn, the second software routine stored in the second memory 96 may be adapted to performn the step of acknowledging the subsequent message by sending a different authenticated and encrypted message from the second organization to the first organization, including an appropriate virtual user ID for the specific end user.

The configurations illustrated in and described with respect to FIGS. 1 and 3 have the ability to provide connections wherein the identity, or even the existence, of the ASP 20 is hidden from the end users 24 and 26. Similarly, the configurations provide the ability for the sponsor site 32 to keep the identities of its users hidden from the ASP 20. Thus, a truly double blind authentication system is created wherein the users are blind to the fact that the ASP 20 is authenticating them and the ASP 20 is blind to which actual user it is authenticating.

In addition to providing double blind authentications, the configurations, on a larger scale, also provide the ability for a user from a company to connect to a system hosted by another company and still maintain his or her privileges. The disclosed method and system for providing an inter-enterprise, single sign-on technique may prove beneficial in a plethora of industries and environments. As previously mentioned, this method is particularly well suited for financial enviromnents, such as banks and investment institutions. However, it also well suited for any application where discretion and confidentiality are valued.

For example, this method would be useful in an aids testing facility wherein patients would be the end users, the service facility would be the sponsor site, and the laboratory performing the actual tests would be the ASP. In this case, the service facility could market its ability to ensure confidentiality to its end users because the testing laboratory would never know the identities of the individual end users. Here, the end users would be more apt to take the test as a result of their confidence in knowing that the testing laboratory could never sell or give information related to identified patients to employers or insurance companies. This confidence level will lead to patients obtaining the medical treatment they need, as well as increasing business for the service facility and the testing laboratory. Of course many other uses for the disclosed technique are also possible.

Although the inter-enterprise, single sign-on technique described herein is preferably implemented in software, it may be implemented in hardware, firmware, etc., and may be implemented by any other processor associated with the interconnected organizations 10. Thus, the routines described herein may be implemented in a standard multi-purpose CPU or on specifically designed hardware or firmware as desired. When implemented in software, the software routine may be stored in any computer readable memory such as on a magnetic disk, a laser disk, or other storage medium, in a RAM or ROM of a computer or processor, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

We claim:

1. A method of connecting an end user associated with a first organization to an application hosted by a second organization while providing double blind authentication wherein the identity of the end user is kept from the second organization and the identity of the second organization is hidden from the end user, the method comprising the steps of:
exchanging digital certificates between the first organization and the second organization;
sending an authenticated and encrypted first message using the digital certificate from the first organization to the second organization, wherein the first message requests a virtual user ID for use by the end user;
validating the digital certificate and decrypting the first message sent by the first organization at the second organization;
responding to the first message by sending an authenticated and encrypted response message comprising an authorized virtual user ID from the second organization to the first organization;
authenticating the end user at the first organization;
mapping an end user's user ID to the virtual user ID;
sending an authenticated and encrypted second message from the first organization to the second organization, the second message including a session initialization request; and
replying to the second message at the second organization with an authenticated and encrypted reply message comprising a session ID.

2. The method of claim 1, wherein the step of sending the authenticated and encrypted first message further comprises:
sending a subsequent authenticated and encrypted message from the first organization to the second organization requesting to modify the authorized virtual user ID for a specific end user; and
acknowledging the subsequent message by sending a different authenticated and encrypted message from the second organization to the first organization including an appropriate virtual user ID for the specific end user.

3. The method of claim 1, further comprising the step of monitoring the session ID to ensure that an end user's session does not become stale.

4. The method of claim 1, wherein the step of authenticating the end user at the first organization is performed after the end user logs on to a web server associated with the first organization.

5. The method of claim 1, wherein the steps of sending the authenticated and encrypted first message, sending the authenticated and encrypted second message, responding to the first message by sending the authenticated and encrypted response message, and replying to the second message at the second organization with the authenticated and encrypted reply message, are performed using Public Key Infrastructure technology.

6. The method of claim 1, wherein the step of exchanging digital certificates is performed via a manual process.

7. The method of claim 6, wherein the manual process is selected from one of U.S. Mail, Courier Mail, or messenger.

8. The method of claim 1, wherein the step of replying to the second message includes passing the session ID as a cookie.

9. The method of claim 1, wherein the step of replying to the second message includes authorizing the end user for use of at least one application associated with the second organization.

10. The method of claim 1, wherein the existence of the second organization remains hidden from the end user.

11. The method of claim 1, wherein the steps of sending the first and the second messages each further comprise the step of sending the first message or the second message over an electronic network.

12. The method of claim 11, wherein the electronic network is one of the internet, a telephone line, and a dedicated line.

13. The method of claim 1, wherein the method of connecting the end user associated with the first organization to the application hosted by the second organization is performed by connecting the end user to the application via an electronic network.

14. The method of claim 1, wherein the first organization and the second organization are financial institutions.

15. A system for connecting an end user associated with a first organization having a first processor to an application hosted by a second organization having a second processor while providing double blind authentication wherein the identity of the end user is kept from the second organization and wherein the identity of the second organization is hidden from the end user, and wherein an electronic network connects the first organization to the second organization, the system comprising:
a first memory and a second memory;
a first software routine stored in the first memory and adapted to be executed on the first processor to execute the steps of;
1) sending an authenticated and encrypted first message using a first digital certificate from the first organization to the second organization requesting an authorized virtual user ID for use by the end user;
2) authenticating the end user;
3) mapping an end user's user ID to an authorized virtual user ID; and
4) sending an authenticated and encrypted second message from the first organization to the second organization, the second message including a session initialization request; and
a second software routine stored in the second memory and adapted to be executed on the second processor to execute the steps of;
1) validating the first digital certificate;
2) decrypting the first message sent by the first software routine;
3) responding to the first message by sending an authenticated and encrypted response message comprising the authorized virtual user ID; and
4) replying to the second message with an authenticated and encrypted reply message using a second digital certificate, wherein the reply message includes a session ID.

16. The system of claim 15, wherein the first software routine is further adapted to perform the step of sending a subsequent authenticated and encrypted message from the first organization to the second organization requesting to modify the authorized virtual user ID for a specific end user; and
wherein the second software routine is further adapted to perform the step of acknowledging the subsequent message by sending a different authenticated and encrypted message from the second organization to the first organization including an appropriate virtual user ID for the specific end user.

17. The system of claim 15, wherein the second software routine stored in the second memory is adapted to perform the step of monitoring the session ID to ensure that an end user's session does not become stale.

18. The system of claim 15, wherein the first software routine stored in the first memory is adapted to perform the step of authenticating the end user after the end user logs on to a web server located at the first organization.

19. The system of claim 15, wherein the first software routine is adapted to authenticate and encrypt the first message and the second message and the second software routine is adapted to authenticate and encrypt the response message and the reply message using Public Key Infrastructure technology.

20. The system of claim 15, wherein the first software routine is adapted to receive and store the first digital certificate and the second software routine is adapted to receive and store the second digital certificate.

21. The system of claim 15, wherein the second software routine stored in the second memory is adapted to perform the step of replying to the second message with an authenticated and encrypted reply message including a session ID) by passing the session ID as a cookie.

22. The system of claim 15, wherein the session ID includes an authorization for at least one application for use by the end user.
